(19) United States
(12) Patent Application Publication
(10) Pub. No.: US 2020/0228630 A1
(43) Pub. Date: Jul. 16, 2020

(54) PERSISTENCE SERVICE FOR EDGE ARCHITECTURES

(71) Applicant: Intel Corporation, Santa Clara, CA (US)

(72) Inventors: Francesc GUIM BERNAT, Barcelona (ES); Karthik KUMAR, Chandler, AZ (US); Dimitrios ZIAKAS, Portland, OR (US); Mark A. SCHMISSEUR, Phoenix, AZ (US); Ned SMITH, Beaverton, OR (US)

(21) Appl. No.: 16/833,448

(22) Filed: Mar. 27, 2020

(51) Int. Cl. H04L 29/08; H04L 12/911; H04L 12/66

(52) U.S. Cl. CPC H04L 67/327; H04L 12/66; H04L 47/82; H04L 67/1097

(57) ABSTRACT

A persistence service for edge architected computing systems extends current storage and memory schemes of edge resources to expose interfaces to allow an endpoint, such as an IoT device or client device, to specify criteria for achieving persistence for data stored in an edge resource. The persistence interface extends the storage and memory controllers to store data in accordance with the criteria, including determining whether a local or remote edge resource is best able to store data persistently in a manner that satisfies the criteria. The criteria include a persistence service level agreement, including a required time to persistence, cost of persistence and reliability level of persistence. Only edge resources that contain media, including storage subsystems and/or memory, capable of storing data persistently while satisfying the criteria will be permitted to service the request. The persistence service can include a discovery service to efficiently locate objects previously stored using the persistence service.

### TECHNICAL FIELD

The descriptions are generally related to data storage, and more particularly to storing data in computer systems in edge computing architectures.

### BACKGROUND

Edge computing architectures have emerged to process large volumes of data closer to the source of the data rather than being processed in a conventional cloud environment. The sources of the data vary greatly, and include smart phones, Internet of Things (IoT) industrial equipment used in manufacturing, aviation (including unmanned aviation), and autonomous cars. The devices that provide the sources of data are collectively referred to herein as an endpoint or client device.

Conventional cloud services have data centers that are typically far away relative to the data sources/endpoints and can take too long to send data/fetch data. In contrast, edge computing architectures push compute resources closer to the source of the data to provide low latency.

### BRIEF DESCRIPTION OF THE DRAWINGS

In the description that follows, examples may include subject matter such as a method, a process, a means for performing acts of the method or process, an apparatus, a memory device, a system, and at least one machine-readable tangible storage medium including instructions that, when performed by a machine or processor, cause the machine or processor to performs acts of the method or process according to described embodiments illustrated by way of example and not limitation in the figures of the accompanying drawings, in which like references indicate similar elements and in which:

FIGS. 1A-1B are schematic block diagrams of a system for a persistence service for edge architectures in accordance with various examples described herein;

FIGS. 2A-2B are schematic block diagrams of edge resources in an edge architected computing system in which a persistence service for edge architectures can be implemented in accordance with various examples described herein;

FIGS. 3-5 are flow diagrams of process flows for providing a system for a persistence service for edge architectures in accordance with various examples described herein;

FIG. 6 is a schematic block diagram of a computing system in which a persistence service for edge architectures can be implemented in accordance with various examples described herein; and

FIG. 7 depicts an example of a data center in which a persistence service for edge architectures can be implemented in accordance with various examples described herein.

### DETAILED DESCRIPTION

Edge computing architectures can be deployed differently depending on the industry and the types of customers served. For example, edge computing architectures were initially deployed to provide data services in mobile communication networks using base stations at the edge of the network. Edge architectures are increasingly used in other industries as well. Enterprise data centers might use edge computing in regional and branch offices to provide data driven and security sensitive services to endpoint devices such as Virtual Private Networks (VPN), firewalls, routing through Software Defined Wide Area Networks (SD-WAN), and workload optimizations through Network Function Virtualization (NFVi). And cloud data centers might integrate edge computing architectures with cloud-based network architectures to enable web-tier services and content delivery to devices, such as client devices, through a network provider or Internet service hub used by consumers on their mobile and/or internet-connected devices. Network data centers might use low-latency and high-bandwidth Multi-access Edge Computing (MEC), a non-cellular edge computing technology, and Radio Access Networks (RAN) to provide edge computing power to endpoint and client devices, particularly for newer communication networks using fifth generation (5G) wireless network technology.

A key advantage of the edge computing paradigm is situating compute resources near an endpoint, such as situating compute resources in an edge gateway near an IoT device or client device. An edge gateway can be any device capable of communicating data between an endpoint and one or more edge resources, including other edge gateways, compute devices and other components owned and/or operated by one or more service providers, such as cellular network operators, or other compute devices located in a cloud network. The edge gateway is typically positioned at one or more locations (e.g., in small cell(s), base station(s), etc.) along the edge of the cloud, i.e., the edge network. Examples of edge gateways and other edge resources include a mobile base station of a network data center, a branch of a regional office of an enterprise data center, or an internet service hub of a cloud service provider. Having the compute resources near the endpoint makes it possible to respond with low-enough latency for most applications, such as IoT applications. For this reason, edge computing has emerged as a preferred means to handle ultra-low latency real-time responses to massive data volumes because conventional computing architectures, such as cloud computing, result in too much latency.

However, the challenge with edge computing is that it is resource constrained. There is a limit to the amount of memory that can be located in servers at a base station, for example. Data on the other hand, often needs to be held in persistent memory and storage subsystems to achieve persistence for real-time processing and low response times.

For some real-time applications, holding data in storage subsystems using disk storage is not an option due to longer response times. For example, several of the real-time applications that use edge computing, such as self-driving cars, emergency alert systems, fraud detection systems, and real-time geo-spatial advertising all have requirements for data that need to achieve persistence so that the data can be processed and responded to as soon as possible.

Another challenge with edge computing is that reliability varies from one edge resource to another. For example, edge data centers have wide variations in ambient conditions such as temperature since they can be situated pretty much anywhere. Edge data centers can often be located in cell phone towers that span various terrains, locations, etc. Further, edge data centers are resource constrained since they are smaller in size, and often situated at challenging locations from a power/cooling perspective. As a result, the temperatures inside the edge data centers can vary significantly. The varied temperature coupled with limited power budgets results in a wide variation in reliability of components at the edge—in particular in persistent memory and storage subsystems. Several edge data centers may have older components, or components that are exposed to higher ambient temperatures, and as a result they have different reliability rates.

For example, it could be that edge data center A in Phoenix, Ariz. in summer has memory components with 98-99.5% reliability due to the high temperatures in the region in summer, but 100 miles north, due to elevation in northern Arizona, the reliability may be 99.9-99.99%. Using this example, the option for an endpoint in Phoenix would be to select a memory/storage edge resource in Phoenix with lowest latency, or “time to persistence,” but also lower reliability, versus an option in Northern Arizona with greater (relative) latency, or greater “time to persistence,” but better reliability.

Data at the edge is also produced from a diverse set of data sources, that can vary greatly in their requirements for achieving persistence, referred to herein as a “reliability of persistence” requirement. For example, it may be sufficient to hold samples of data from a temperature sensor in a building with 95% reliability of persistence, but samples from a drone sensor might require 99% reliability of persistence and samples from a sensor in a self-driving automobile of might require 99.99999% reliability of persistence.

Unfortunately, there is no means today for the endpoint data sources to specify these varying reliability of persistence requirements to an edge service and map them to the reliability of components in the underlying infrastructure of edge gateways and other edge resources. Currently, the only way to provide more reliable persistence is to employ worst case provisioning which can result in over-provisioning. This results in inefficient usage of memory and storage resources at the edge.

Accordingly, there is a need to track where the sources of data of an endpoint is situated, and provide the endpoint device with a persistence service that takes into account tradeoffs such as reliability, latency of access, and cost of achieving persistence of the data in a particular edge gateway/edge resource, including an amount of time required to achieve persistence.

To address the challenge of achieving persistence for data stored in an edge gateway or other edge resource in an efficient manner, embodiments of a persistence service for edge architectures expose an interface for endpoints to specify criteria for achieving persistence for data stored in an edge gateway or other edge resource based on the specified criteria. As contemplated in the present disclosure, the interface extends current storage and memory schemes of the edge resources of an edge architected system to allow endpoints to specify different types of criteria for achieving persistence when storing their data.

In one embodiment, a persistence service of an edge computing architecture offers “time to persistence” as a service to endpoints (the edge users). “Time to persistence” can often be a function of other factors at an edge gateway or other edge resource, including reliability of edge components, cost for the edge service, etc. The persistence service includes infrastructure and telemetry to track various metrics that enable the persistence service. In addition, the persistence service tracks the edge locations where data is stored upon achieving persistence and communicates the edge locations back to endpoints or saves the edge locations in a phone-book like dictionary store for subsequent lookup and retrieval.

In one embodiment, an edge gateway that provides storage at a particular edge location is not only aware on the different persistence or durability features of local memory and storage media, it is aware of durability properties of other accessible edge gateways/edge resources as well as the reliability of connection(s) to them. In one embodiment, an edge gateway can forward an endpoint's request to store data using the persistence service to the edge gateway/edge resource most capable of making the endpoint's data durable (persistent) within the specified criteria for achieving persistence, including within a threshold “time to persistence” service level agreement (SLA). In one embodiment, the persistence service includes system telemetry to estimate the time to achieve persistence given current conditions, such as current bandwidth and latency of a connection to an edge resource or the current conditions of the local media on an edge gateway or remote storage locations in an edge resource connected to the edge gateway. In one embodiment, a persistence service includes infrastructure that is capable, once an object is made persistent, to redirect requests to that object to a corresponding edge hosting that object. In one embodiment, the persistence service accounts for SLAs other than the threshold “time to persistence,” including a “cost to persistence,” where the cost is a dollar amount associated with achieving persistence according to the endpoint-specified criteria.

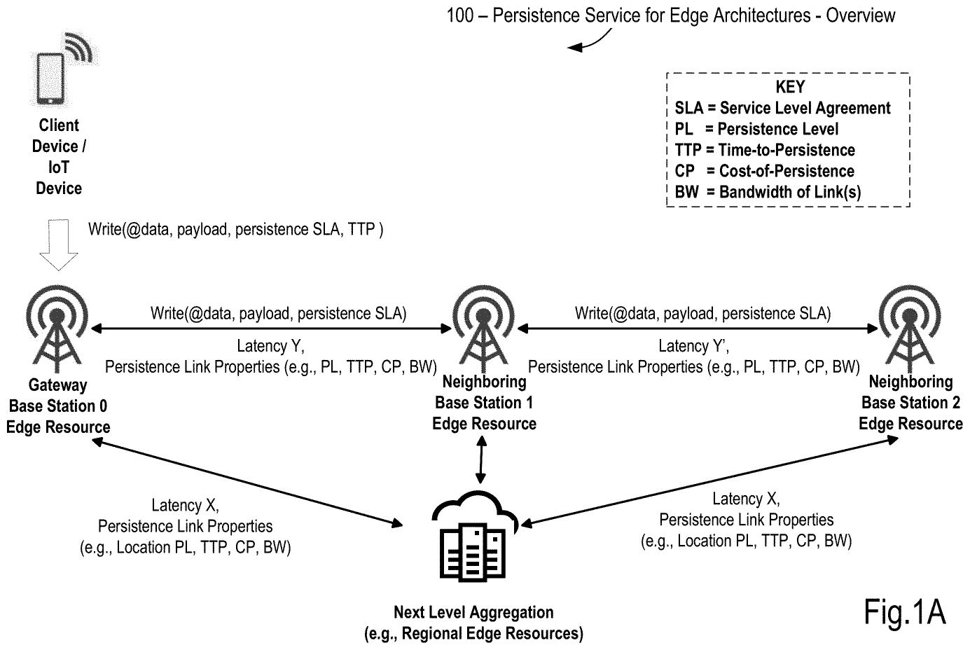

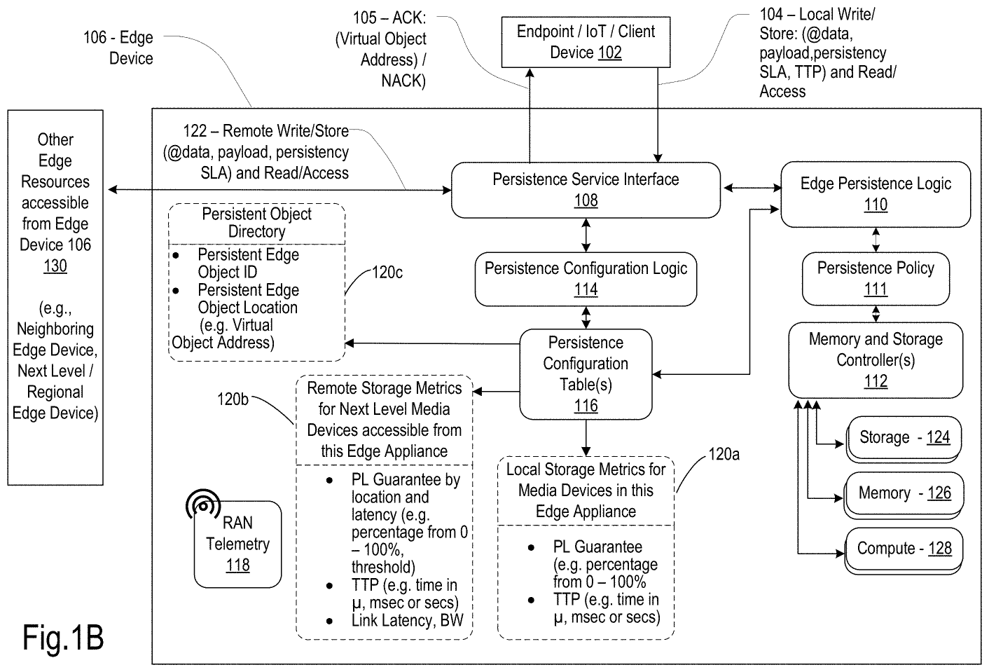

FIG. 1A illustrates an example edge computing system 100 in which embodiments of a persistence service for edge architectures provide endpoints, such as IoT devices or client devices, including any device from which data can originate (hereafter collectively referred to simply as endpoints), and the edge resources to which they are connected, with more efficient mechanisms to specify how their data is stored to achieve persistence in the edge gateways and other edge resources of the edge architecture.

In one embodiment a distributed edge architecture includes a gateway base station 0 and neighboring base stations 1 and 2, each of which is connected to a next level aggregation of edge architecture, such as a regional edge resource, all of which are collectively referred to as the edge resources of a distributed edge architecture. The edge resources are aware of the characteristics of durability of themselves and each other through system telemetry. The characteristics of durability as used herein generally refer to reliability and persistence of data stored in edge resources. The system telemetry tracks durability of the memory and storage subsystems hosted in edge resources as well as latency between edge resources.

In one embodiment the characteristics of durability are included in persistence link properties. Among other properties, persistence link properties include a persistence level (PL) to identify a level of reliability associated with the persistence of an edge resource where PL is typically expressed as a number representing a percentage guaranty, such as 80 percent, 90 percent, and so forth. In one embodiment the PL can include a list of values or just a threshold number. In one embodiment, the PL can be associated with the reliability of a link, not just an edge resource. Persistence link properties also include a time-to-persistence (TTP) to identify how much time is required to achieve persistence in the edge resource, a cost-of-persistence (CP) to indicate how much it will cost to achieve persistence in an edge resource, and a bandwidth (BW) of a link between one edge resource and another edge resource. BW typically reflects a current BW but can also be a static BW or last know BW to a particular location. In a typical embodiment, the BW of the link can affect latency, such as Latency Y, Latency Y′, Latency X and Latency X′ between two edge resources, which in turn can affect the PL, TTP and CP. The latency can be a static latency, last known latency or a currently latency to another edge resource.

In one embodiment, an endpoint, such as a client device/IoT device can use the persistence service to issue a write command that specifies any of a persistence SLA (service level agreement) and TTP criteria for achieving persistence of the data in the write command's payload. In response, the receiving edge resource, in this case the gateway base station 0 edge resource, includes an interface and associated logic for determining how best to satisfy the endpoint's write command in accordance with the specified criteria for achieving persistence of the data in the write command's payload.

FIG. 1B illustrates an example of an edge device 106 that represents any of an edge gateway or other edge resource 130 of an edge architecture. In one embodiment an endpoint 102, including an IoT or client device such as a mobile telephone or other device having a sensor and computing capability, is wirelessly connected to an edge resource such as the edge device 106. The edge device 106 (and edge gateway or any of the other edge resources, including neighboring and next level edge resources) can include, among other components a Radio Access Network (RAN) telemetry 118, a persistence service interface 108 connected to a persistence configuration logic 114 and an edge persistence logic 110. The edge persistence logic 110 in coordination with a persistence policy 111 and persistence configuration table(s) 116 control the operation of memory and storage controller(s) 112 which, in turn, control the storage 124, memory 126 and compute 128 resources of the edge device 106. The illustrated system 100 might be used, for example, by a communication service provider in conjunction with a network data center to provide 5G-enabled services, including massive data-generating and consuming services such as virtual/augmented reality and autonomous driving.

In one embodiment, the storage 124 and memory 126 resources may include volatile types of memory including, but not limited to, random-access memory (RAM), dynamic RAM (D-RAM), double data rate (DDR) SDRAM, SRAM, T-RAM or Z-RAM. One example of volatile memory includes DRAM, or some variant such as SDRAM. The storage 124 and memory 126 resources can include a memory subsystem that is compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WI02 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (LPDDR version 5, currently in discussion by JEDEC), HBM2 (HBM version 2, currently in discussion by JEDEC), and/or others, and technologies based on derivatives or extensions of such specifications.

However, examples are not limited in this manner, and in some instances, any storage 124 and memory 126 resources may include non-volatile types of memory, whose state is determinate even if power is interrupted to a memory. In some examples, memory may include non-volatile types of memory that is a block addressable, such as for NAND or NOR technologies. Thus, memory can also include a future generation of types of non-volatile memory, such as a 3-dimensional cross-point memory (3D XPoint™ commercially available from Intel Corporation), or other byte addressable non-volatile types of memory. According to some examples, memory may include types of non-volatile memory that include chalcogenide glass, multi-threshold level NAND flash memory, NOR flash memory, single or multi-level Phase Change Memory (PCM), a resistive memory, nanowire memory, FeTRAM, MRAM that incorporates memristor technology, or STT-MRAM, or a combination of any of the above, or other memory.

In one embodiment, the compute resources 128 may include processors that are designed for a broad range of lower-power high-density edge computing needs, such as the Intel® Zeon® D-series of multi-core processors having up to 512 GB of addressable memory, an integrated platform controller hub, integrated high-speed I/O and multiple 10 Gigabit Ethernet ports that can provide server-class operating capacity.

Embodiments of a persistence service for edge architectures can be used with any type of edge device 106 such as edge gateways that serve as access points at the far edge of a network, such as a small cell of a mobile wireless network or a wireless access point, and other edge resources that serve as points of aggregation, such as a base station or cell tower. Embodiments of a persistence service for edge architectures can also be used in network environments other than mobile communication networks, including in enterprise and fixed area networks. For example, an edge device 106 could function as an access point or point of aggregation in a multi-access edge computing (MEC) and virtualized Radio Access Networks (vRAN) environment of an enterprise data center or as an access point or point of aggregation for an internet service hub of a cloud data center.

Embodiments of a persistence service for edge architectures can also leverage the capabilities of distributed data storage using a disaggregated architecture. Disaggregated architecture refers to disaggregated resources (e.g., memory devices, data storage devices, accelerator devices, general purpose processors) that are selectively allocated, deallocated and logically coupled to form a composed node. The composed node can function as an edge resource, for example, a storage server located at the edge of a network data center. Various data center hardware resources, such as compute modules, non-volatile memory modules, hard disk (HDD) storage modules, FPGA modules, and networking modules, can be installed individually within a rack. These can be packaged as blades, sleds, chassis, drawers or larger physical configurations. Disaggregated architecture improves the operation and resource usage of a data center relative to data centers that use conventional storage servers containing compute, memory and storage in a single chassis. In one embodiment, a persistence service for edge architectures can be provided completely within a disaggregated architecture, such as the Intel® Rack Scale Design (RSD) architecture provided by Intel Corporation.

In one embodiment an edge device 106 such as edge gateway includes a persistence service interface 108 and persistence configuration 114 logic to receive and store in one or more persistence configuration table(s) 116 various metrics for determining persistence characteristics, such as TTP (time to persistence) and CP (cost of persistence), associated with a particular media device (e.g. a memory 126 or storage 124 device) in this edge device 106 or another edge resource 130 accessible from this edge device 106. The local storage metrics 120a include any of a PL guarantee and a TTP, where the PL guarantee can be expressed as a percentage and the TTP can be expressed as an amount of time, in milliseconds, seconds or microseconds, until data achieves persistence. The remote storage metrics 120b for the other edge resources 130 include the PL guarantee and TTP and further include a link latency and bandwidth (BW) of the connection between the edge device 106 (such as an edge gateway) and other edge resource(s) 130.

In one embodiment, the persistence configuration tables 116 include a persistent object directory 120c. The persistent object directory includes a persistent edge object ID of objects that have achieved persistence using the persistence service, as well as a persistent edge object location. In one embodiment, for example, the virtual object address of the object that has achieved persistence is stored in the persistent object directory. The virtual object address directory entry is a pointer to a remote object data store that contains the actual object.

In one embodiment, in operation, the endpoint 102 specifies the criteria for achieving persistence of a data payload in write/store commands 104 received in the edge device 106. Alternatively, a remote write/store command can be received from another edge resource 120 accessible to the edge device 106. The current metrics for determining whether persistence of the data can be achieved in satisfaction of the criteria specified in the write/store commands 104 are found in the local storage metrics 120a and the remote storage metrics 120b. In one embodiment, the edge persistence logic 110 determines which component (e.g. storage 124, memory 126) of which edge device 106 or other edge resource 130 accessible from the edge device 106, is capable of achieving persistence within the specified criteria in the write/store command 104 based on the current metrics 120a/120b. If the edge persistence logic 110 determines that it can satisfy the endpoint's request, then an ACK 105 is transmitted back to the endpoint 102. If not, then a NACK is transmitted back to the endpoint 102.

In one embodiment, in operation, the endpoint 102 issues a read/access command 104 for a previously persisted data, such as an object that was previously made persistent in memory 126 or storage 124 in either the edge device 106 or another edge resource 130 accessible from the edge device 106. Alternatively, a remote read/access command 122 for a previously persisted data can be received from another edge resource 130 accessible to the edge device 106.

In one embodiment, a persistence configuration logic 114 is also included in edge device 106 to receive configuration information from the edge device 106 owner. For example, the persistence configuration logic 114 allows the edge owner of edge device 106 to specify the other edge resources 130 to which it has access and is interested in monitoring for persistence service purposes. In one embodiment, a persistence configuration logic 114 is responsible for maintaining the persistence configuration tables 116 and managing the compute resources 128 to determine how best to achieve persistence on behalf of the endpoints.

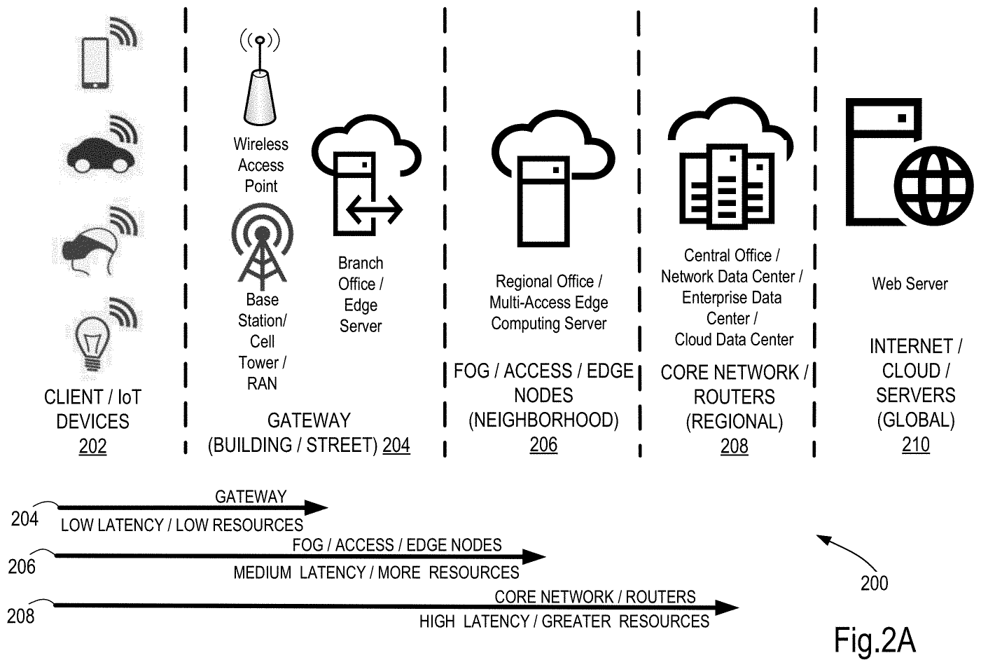

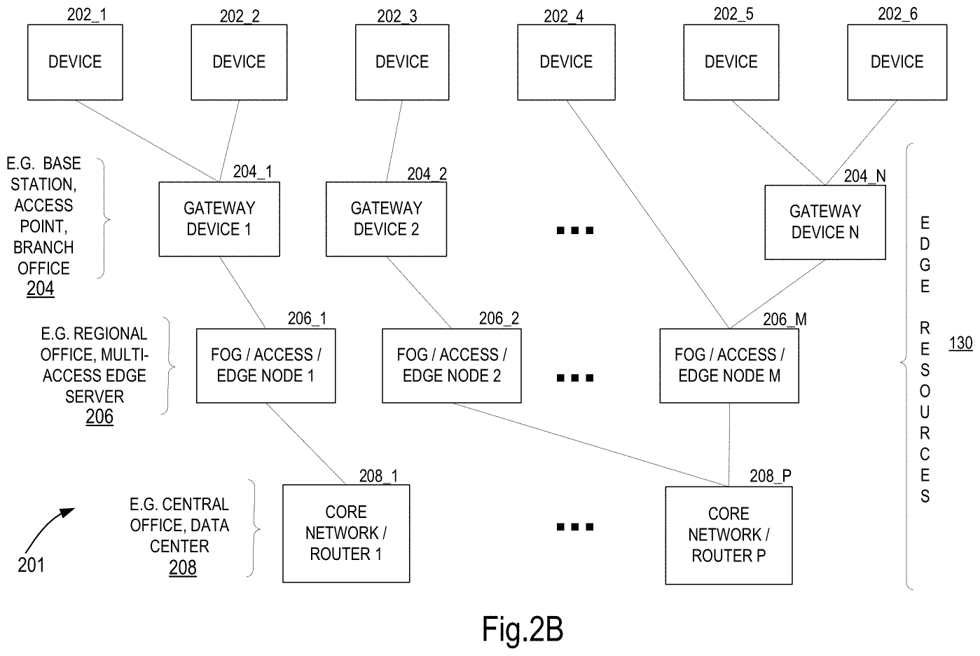

FIGS. 2A-2B illustrate an example edge architecture computing environment 200 in which a persistence service for edge architectures can be deployed in accordance with the examples described herein. As depicted, the edge architecture computing environment 200 serves numerous types of devices 202 including but not limited to smart phones, autonomous vehicles, augmented reality devices and a wide variety of other IoT devices that generate data for edge computing. The edge resources of the edge architecture computing environment 200 include edge gateways 204 housed, for example, at the building and street level, include wireless access points, base station/cell towers, radio access networks (RAN), branch offices and edge servers, all of which can function as access points for the devices 202. Edge nodes 206, also referred to as fog or access nodes, are edge resources positioned at the neighborhood level, and include regional offices that serve as points of aggregation for edge gateways 204, and/or multi-access (wired and wireless) edge computing servers for providing real-time, high-bandwidth, low-latency access to radio network information. The core network/routers 208 are edge resources positioned at the regional level and include a central office that serves as a point of aggregation for the neighborhood level edge resources, a network data center, and enterprise data center and a cloud data center, all of which can be integrated with the lower level edge resources to provide access to global resources 210, such as web and cloud servers accessed via the internet.

As illustrated, the edge resource capacities vary in terms of latency in providing services and accessing data, and in terms of memory and storage resources for storing data. For example, the gateways 204 provide low latency because of their proximity to the edge devices 202, but they have fewer resources for memory and storage. The neighborhood level edge nodes 206 still provide relatively low latency as compared to more remote servers situated in regional data centers 208 and beyond 210, but not as low as the latency of the gateways 204. However, the neighborhood level edge nodes 206 typically have more capacity in terms of memory and storage resources than gateways 204. Lastly, the regional level core network/routers 208 have even greater capacity in terms of memory and storage resources. But due to their distance from the devices 202, the regional level core network/routers 208 experience high latency in providing services at the edge of an edge architected system.

FIG. 2B illustrates an example arrangement of edge resources in an edge architected computing system 201 in which embodiments of a persistence service for edge architectures can be implemented. Devices 202_1, 202_2, 202_3, 202_4, 202_5 and 202_6 are representative of any number of devices 202 that can benefit from an edge architected computing system 201. For example, the number of devices 202 in an edge architected computing system 201 can be in the thousands, millions, or even billions of devices.

A device 202_1 through 202_6 can be any device capable of computing data and communicating with other system components either wirelessly or via a wired connection. Examples of devices 202_1 through 202_6 are depicted in FIG. 2A. For example, in an embodiment a device can be a cellular mobile telephone such as a smartphone. In another embodiment, a device can be an IoT-enabled device including a sensor and computing capability in an IoT network. Many other devices are contemplated, and embodiments of the present invention are not limited in this respect.

In one embodiment, numerous devices 202_1 through 202_6 are connected to a network of edge resources, referred to as the edge architected computing system 201. For example, a communication service provider can build an edge architected computing system 201 comprising small cell, base station and central office systems to provide low latency high bandwidth connections to devices 202_1 through 202_6 at the edge of a communication network, close to where the edge devices are located. As another example, a communication service provider can build an edge architected computing system 201 to deliver customized enterprise networking services, like Virtual Private Networks (VPN), firewalls, routing through Software Defined Wide Area Networks (SD-WAN), and workload optimizations through Network Function Virtualization (NFVi) using a network of tiered systems located in regional and branch offices. In another example, a cloud service provider can build an edge architected computing system 201 to deliver low latency high bandwidth cloud services using a network provider or internet service hub.

As shown, edge architected computing system 201 typically includes three levels (not counting the devices 202 as “leaf” nodes in the tree structure of FIG. 2B), although in other embodiments, other numbers of levels can be used. In embodiments, there can be any number of edge resources at each level. That is, there can be, for example, any number “N” of gateway devices 204_1, 204_2, . . . 204_N, any number “M” of fog/access/edge nodes 206_1, 206_2, . . . 206_M, and any number “P” of core network/routers, 208_1, . . . 208_P, where N, M, and P are natural numbers. In an embodiment, the number of devices 202 can be greater than the number N of gateway devices 204, the number N of gateway devices can be greater than the number M of fog/access/edge nodes 206, and the number M of fog/access/edge nodes can be greater than the number P of core network/routers 208.

In one embodiment, each edge resource may communicate with another edge resource either wirelessly or via a wired connection. The computing system architecture of embodiments of the present invention is scalable and extensible to any size and geographic area. In one embodiment, the computing system architecture may encompass a geographic area as large as the Earth and include as many edge resources 130 and levels 204, 206 and 208 as are needed to meet system requirements for service to devices 202. In an embodiment, a device 202_4 may communicate with a single gateway device 204 or fog/access/edge node 206 and multiple other edge resources, and a fog/access/edge node 206 may communicate with a single core network/router 208 and multiple other fog/access/edge nodes, and a core network/router 208 may communicate with other core network/routers. For example, gateway device 1 204_1 can communicate with fog/access/edge node 1 206_1, which may in turn communicate with core network/router 1 208_1, and so on as shown in the example hierarchical structure of FIG. 2B.

An edge gateway such as gateway device 1 204_1 can communicate “downstream” with any number devices 202, such as devices 202_1 through 202_6, and “upstream” with a fog/access/edge node such as edge node 1 206_1. As another example, devices 202_1 through 202_2 may communicate with gateway device 2 204_1, and client 202_5 and 202_6 may communicate with gateway device N 204_N. In an embodiment, the number of devices 202 that an edge gateway 204 communicates with may be limited by the computational and communication capacity of the gateway device. In an embodiment, devices may also communicate directly with a regional level device, such as is shown for devices 202_4 and fog/access/edge node M 206_M. Thus, a regional level edge resource may communicate “downstream” with devices 202 and/or gateway devices 204, and also “upstream” with a core network/router 208.

In edge architected computing system 201, devices 202 can be stationary or mobile. When devices 202 are mobile (such as smartphones, for example), devices may communicate at times with different edge gateways 204 as the devices move around in different geographic areas. Each device 202 communicates with only one level of edge resources at a time. When devices are stationary, they may communicate with a specific edge gateway 204 or for/access/edge node 206 regional level device allocated to the geographic area where the device 202 is located.

In one embodiment, an edge gateway (such as gateway device 1 204_1) includes a small cell. Small cells are low-powered cellular radio access nodes (RANs) that operate in licensed and unlicensed spectrum that have a range of 10 meters within urban and in-building locations to a few kilometers in rural locations. They are “small” compared to a mobile macro-cell, partly because they have a shorter range and partly because they typically handle fewer concurrent calls or sessions. They make best use of available spectrum by re-using the same frequencies many times within a geographical area. Fewer new macro-cell sites are being built, with larger numbers of small cells recognized as an important method of increasing cellular network capacity, quality and resilience with a growing focus using LTE (Long Term Evolution) Advanced and 5G mobile communication standards. Small-cell networks can also be realized by means of distributed radio technology using centralized baseband units and remote radio heads. These approaches to small cells all feature central management by mobile network operators.

Other types of edge resources 130 can comprise the edge architected computing system 201. For example, in one embodiment, a building/street level or neighborhood level edge resource (such as edge gateway 1 204_1 and fog/access edge node M 206_M) includes an access point to a radio access network (RAN) of a multi-access edge computing (MEC) network of a larger core network/router 208 of a network data center at the regional level, or an access point to an Internet service hub of a core network/router 208 of a cloud data center.

In one embodiment, a building/street level and neighborhood level edge resource (such as gateway device 1 204_1 or fog/access/edge node 1 206_1) includes a base station controlling multiple small cells and interaction with the upper tiers of a mobile wireless communication network, such as a central office or network data center at the regional level, e.g., a core network/router 1 208_1. Alternatively, or in addition, a fog/access/edge node 206 can also interact with an enterprise data center, or an internet service hub of a cloud data center at the regional level, e.g., core network router P 208_P.

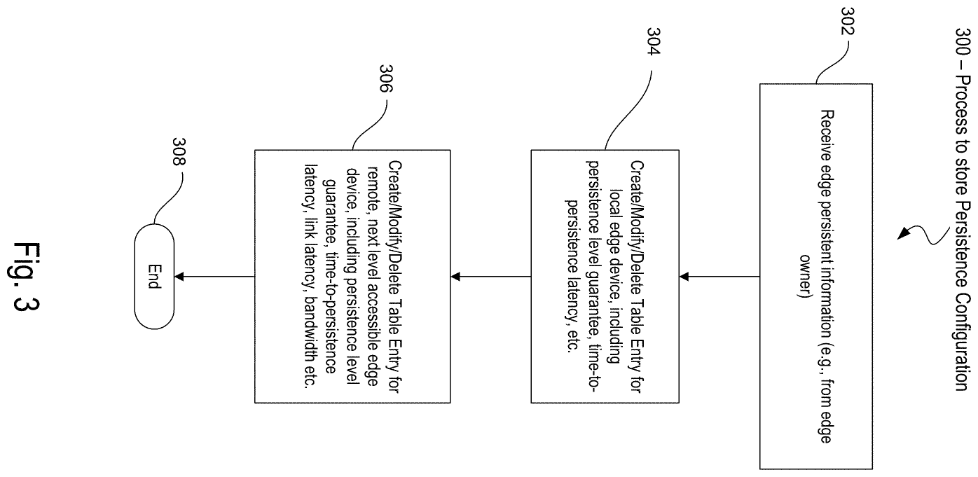

FIGS. 3, 4 and 5 illustrate example logic flows of a persistence service process as introduced in the persistence configuration logic 114 in FIG. 1 and the persistence service interface 108 in FIG. 1. The set of logic flows in FIGS. 3, 4 and 5 are representative of example methodologies for performing novel aspects of the disclosed persistence service for an edge architected computing system. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow can be implemented in software, firmware, and/or hardware. In software and firmware embodiments, a logic flow can be implemented by computer executable instructions stored on at least one non-transitory computer readable medium or machine readable medium, such as an optical, magnetic or semiconductor storage. The embodiments are not limited in this context.

At block 302, a persistence configuration process 300 receives edge persistent information, typically from an edge device owner. At block 304 the process creates, modifies or deletes a table entry for a local media (storage 124 or memory 126) in an edge device. For example, for each of the media devices in a local appliance (the edge device), the process maintains edge persistent information such as a persistence level (PL) at which the media device can guarantee persistence. In one embodiment, the level is a number representing a percentage from 0 to 100%. As another example, for each of the media devices in the edge device, the process maintains a time that it takes to achieve persistence in that particular device (TTP), where the time can be expressed in microsecond, milliseconds or seconds.

In one embodiment, at 306, a persistence configuration process 300 receives edge persistent information for remote devices that are accessible from an edge device, typically from system telemetry such as RAN Telemetry 118. Similar to block 304, the process creates, modifies or deletes a table entry, this time for each remote, neighboring or next level accessible edge resource. The table entry includes persistence level (PL) guarantee and the time it takes to achieve persistence (TTP). In addition, the table entry includes the latency of the link connection between the edge device and the remote device (e.g. the neighboring or next level edge resource) for which the table entry is maintained and a current bandwidth (BW) of the link connection. In one embodiment the information in the table entry is represented as persistence link properties associated with the remote device, including a cost of persistence (CP) at the remote device (e.g. the neighboring or next level edge resource).

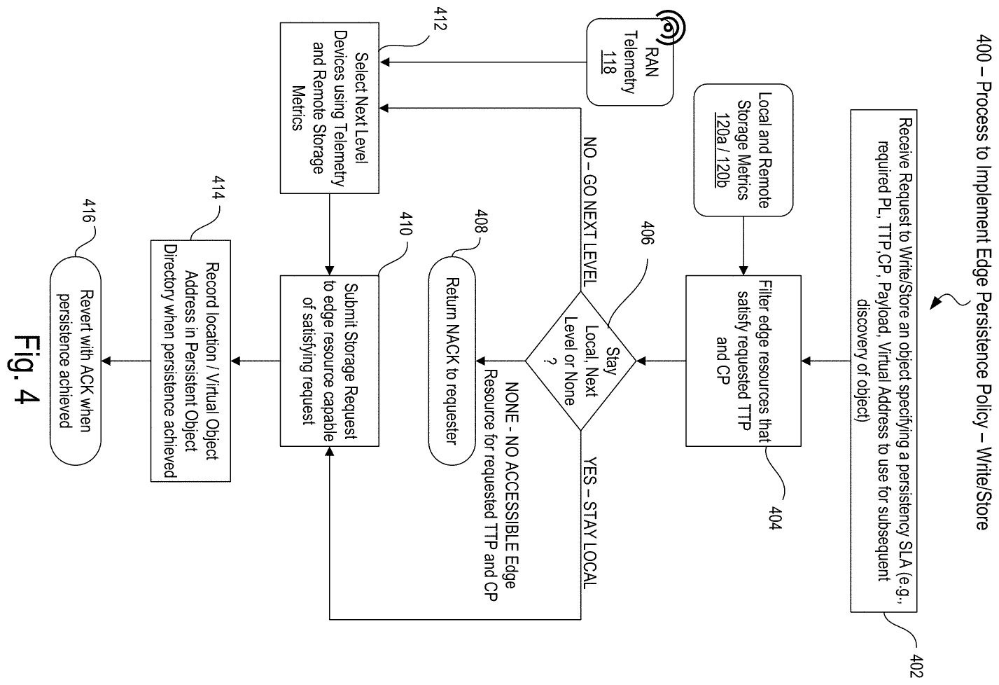

FIG. 4 illustrates a process flow 400 to implement an edge persistence policy 111 upon receiving a write/store command at an edge device, such as an edge gateway. At block 402, the process receives a request to Write/Store an object specifying a persistence SLA, including a required persistence level (PL) and a required time to persistence (TTP). In one embodiment, the request further specifies a threshold maximum cost of persistence (CP) not to be exceeded. The remainder of the write/store command includes the payload of the data object, and, optionally, a virtual address to use for subsequent discovery of the object once persistence has been achieved.

In one embodiment, at 404, the process filters edge resources, i.e., the local edge device and accessible remote edge resources, based on whether they contain media that can satisfy the TTP (and CP) as specified in the write/store request. In one embodiment, the filter process obtains the information from the local and remote storage metrics 120a/120b maintained in the receiving edge device 106.

At decision block 406, the process determines whether to stay local or go to the next level (e.g. one of the remote devices) to store the payload, or whether there are no edge resources currently available that can satisfy the write/store request. If the latter than the process 400 terminates and returns a NACK to the requester endpoint. To go to the next level, the process branches to block 412 to select the next level devices using the telemetry 118 and remote storage metrics 120b before branching to block 410 to submit the write/storage request to the edge resource that is capable of satisfying the request. To stay local, the process branches directly to block 410 to submit the write/storage request to the local edge device and media that is capable of satisfying the request.

In determining whether to stay local, go to the next level or return a NACK without satisfying a request received via the persistence interface, recall that data at the edge is produced from a diverse set of data sources/endpoints. Accordingly, there is a variety in “reliability of persistence” requirements. For example, it may be sufficient to hold with 95% reliability samples of data from a temperature sensor in a building but require 99% of the samples from a drone sensor, and 99.99999% of the samples from a sensor in a self-driving automobile. Thus, the actual determination made during the filtering block 404 and decision block 406 greatly depends on the interplay between the “reliability of persistence” requirements specified by the endpoint and the current local and remote storage metrics 120a/120b of the available edge resources in the edge architected system.

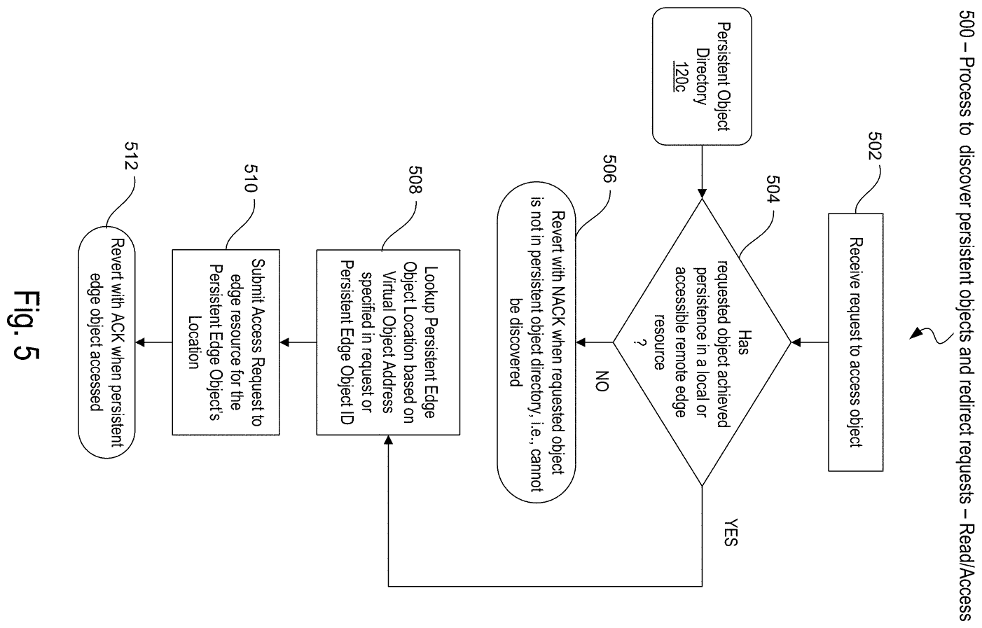

In one embodiment, the process then concludes at 414 to record a virtual object address in a persistent object directory when persistence is achieved. The process then reverts at 416 to the requester with an ACK when persistence is achieved. The recorded virtual object address will be used in a subsequent read/access command to quickly access the persistent object as set forth below in FIG. 5.

FIG. 5 illustrates a process flow 500 to discover persistent objects and redirect requests to read/access them accordingly. At block 502, an edge device receives a request to access an object using a persistent edge object ID. At decision block 504, the process determines whether the requested object achieved persistence in any of a local or accessible remote edge resource using a lookup by object ID to the persistent object directory 120c. If not, the process terminates at 506 and reverts with a NACK when the requested object is not in the persistent object directory, i.e., cannot be discovered.

In one embodiment, if the object ID is found in the persistent object directory 120c, at block 508 the process continues with a look up to the persistent edge object location, including a location based on a virtual object address specified in a write/store request at the time the object achieved persistence and/or an address associated with the object ID. At block 510, the process submits the read/access request to the edge resource associated with the persistent edge object's location found in the persistent object directory 120c. Subsequently, at block 512, the process terminates and reverts with an ACK when the persistent object is accessed.

In summary, the determination of which edge resource, a local edge resource or a remote edge resource, is best capable of providing persistent storage within the specified criteria as to PL, TTP and CP, allows endpoints to make better use of the edge resources that are available at the time of their requests. Those endpoints that can tolerate greater latency at the expense of greater reliability may be directed to remote edge resources, while endpoints that can make use of the local media devices can stay local. Alternatively, a local edge resource whose media devices are unreliable or unavailable can still function as a pass-through gateway to a remote edge resource that can satisfy requests from endpoints.

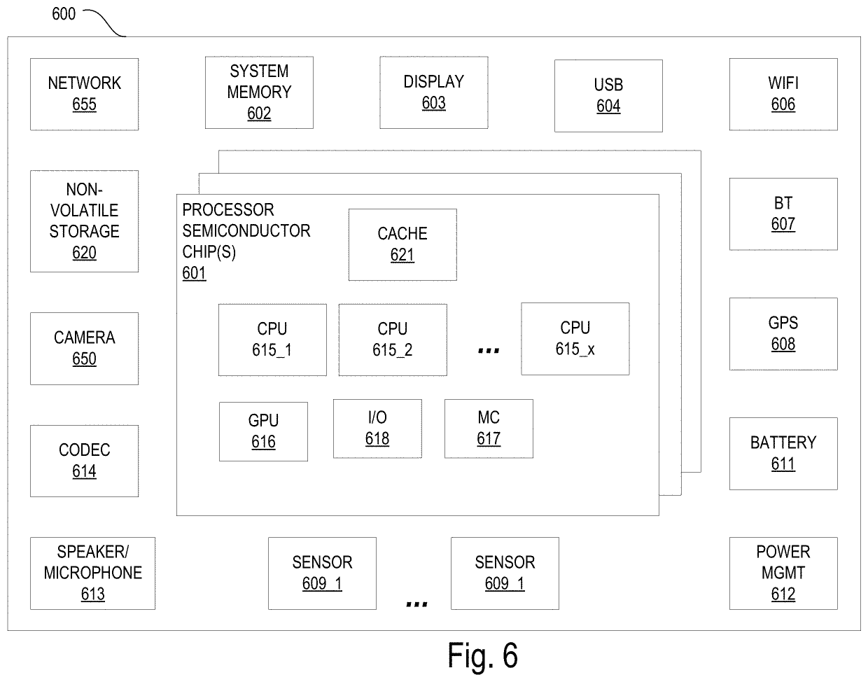

FIG. 6 illustrates an example computing system 600 in which embodiments of a persistence service for edge architectures can be implemented. According to some examples, computing system 600 may include, but is not limited to, an edge resource, including an edge device, and edge gateway, and an edge node, a small cell, a base station, a central office switching equipment, a server, a server array or server farm, a web server, a network server, an Internet server, a work station, a mini-computer, a main frame computer, a supercomputer, a network appliance, a web appliance, a distributed computing system, a personal computer, a tablet computer, a smart phone, multiprocessor systems, processor-based systems, or combination thereof.

As observed in FIG. 6, the computing system 600 may include at least one processor semiconductor chip 601. Computing system 600 may further include at least one system memory 602, a display 603 (e.g., touchscreen, flat-panel), a local wired point-to-point link (e.g., USB) interface 604, various network I/O functions 655 (such as an Ethernet interface and/or cellular modem subsystem), a wireless local area network (e.g., Wi-Fi) interface 606, a wireless point-to-point link (e.g., Bluetooth (BT)) interface 607 and a Global Positioning System (GPS) interface 608, various sensors 609_1 through 609_Y, one or more cameras 650, a battery 611, a power management control unit (PWR MGT) 612, a speaker and microphone (SPKR/MIC) 613 and an audio coder/decoder (codec) 614. The power management control unit 612 generally controls the power consumption of the system 600.

An applications processor or multi-core processor 601 may include one or more general purpose processing cores 615 within processor semiconductor chip 601, one or more graphical processing units (GPUs) 616, a memory management function 617 (e.g., a memory controller (MC)) and an I/O control function 618. The general-purpose processing cores 615 execute the operating system and application software of the computing system. The graphics processing unit 616 executes graphics intensive functions to, e.g., generate graphics information that is presented on the display 603. The memory control function 617 interfaces with the system memory 602 to write/read data to/from system memory 602.

Each of the touchscreen display 603, the communication interfaces 604, 655, 606, 607, the GPS interface 608, the sensors 609, the camera(s) 610, and the speaker/microphone codec 613, and codec 614 all can be viewed as various forms of I/O (input and/or output) relative to the overall computing system including, where appropriate, an integrated peripheral device as well (e.g., the one or more cameras 610). Depending on implementation, various ones of these I/O components can be integrated on the applications processor/multi-core processor 601 or can be located off the die or outside the package of the applications processor/multi-core processor 601. The computing system also includes non-volatile storage 620 which can be the mass storage component of the system.

Computing system 600 may also include components for communicating wirelessly with other devices over a cellular telephone communications network is as known in the art. Various examples of computing system 600 when embodied as a small cell, base station, or central office may omit some components discussed above for FIG. 6.

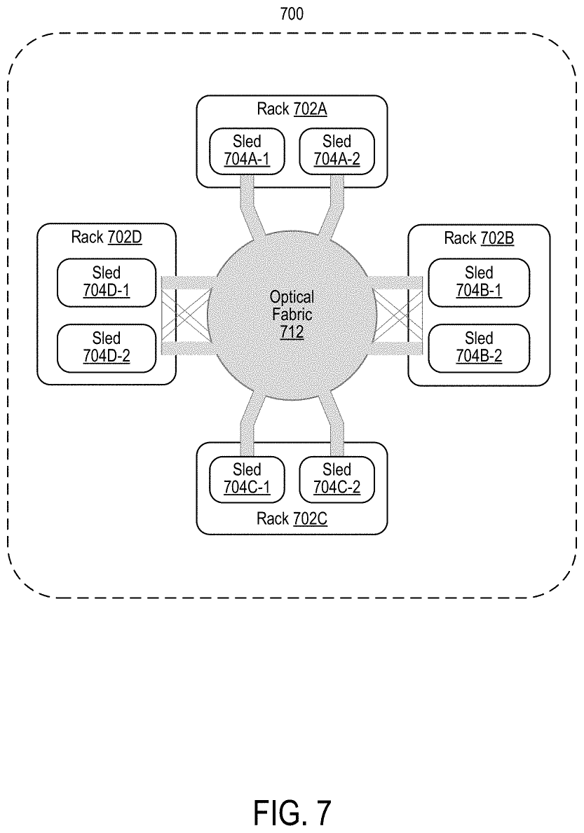

FIG. 7 depicts an example of a data center in accordance with which embodiments of a persistence service for edge architectures can be used. As shown in FIG. 7, data center 700 may include an optical fabric 712. Optical fabric 712 may generally include a combination of optical signaling media (such as optical cabling) and optical switching infrastructure via which any sled in data center 700 can send signals to (and receive signals from) the other sleds in data center 700. The signaling connectivity that optical fabric 712 provides to any given sled may include connectivity both to other sleds in a same rack and sleds in other racks. Data center 700 includes four racks 702A to 702D and racks 702A to 702D house respective pairs of sleds 704A-1 and 704A-2, 704B-1 and 704B-2, 704C-1 and 704C-2, and 704D-1 and 704D-2. Thus, in this example, data center 700 includes a total of eight sleds. Optical fabric 7012 can provide sled signaling connectivity with one or more of the seven other sleds. For example, via optical fabric 7012, sled 704A-1 in rack 702A may possess signaling connectivity with sled 704A-2 in rack 702A, as well as the six other sleds 704B-1, 704B-2, 704C-1, 704C-2, 704D-1, and 704D-2 that are distributed among the other racks 702B, 702C, and 702D of data center 700. The embodiments are not limited to this example. For example, fabric 712 can provide optical and/or electrical signaling.

Various examples can be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples might be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples might be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

Additional example implementations are as follows:

An example method, system, apparatus or computer-readable medium to enable a persistence service in edge architected systems comprises a compute resource coupled to a storage resource, the compute resource to execute a logic to receive a request to store data at an edge of a network, the request specifying a criterion for achieving persistence of stored data, determine that one or more edge resources at the edge of the network is capable of satisfying the criterion, and submit the request to store data to a selected one of the one or more edge resources capable of satisfying the criterion.

In another example implementation, the criterion for achieving persistence of stored data includes any one or more of a time within which to achieve persistence, a cost within which to achieve persistence, and a reliability with which to achieve persistence within any of the time and the cost.

In another example implementation, the one or more edge resources at the edge of the network includes a local edge resource in which the request was received, the local edge resource to control one or more local storage locations at the edge of the network. In addition, to determine that one or more edge resources at the edge of the network is capable of satisfying the criterion is to determine that any one or more local storage locations is capable of satisfying the criterion based on local storage metrics for the one or more local storage locations including any of a reliability metric and a time metric, and a cost to store data in the one or more local storage locations based on the time and reliability metrics.

In another example implementation, the one or more edge resources at the edge of the network further includes one or more remote edge resources accessible to the local edge resource. In addition, to determine that one or more remote edge resources is capable of satisfying the criterion is based on remote storage metrics for one or more remote storage locations including any of a remote reliability metric, a remote time metric, and a remote latency metric of a link from the local edge resource to the remote edge resource, and further including a remote cost to store data in the one or more remote storage locations based on the remote reliability, remote time and remote latency metrics.

In another example implementation, the compute resource is to further execute logic to track via a radio access network (RAN) telemetry data provided to the local edge resource, one or more persistence properties of the one or more remote edge resources at the edge of the network, the one or more persistence properties including any of a persistence level (PL) indicating any of a percentage and a number representing the remote reliability metric, a time-to-persistence (TTP) representing the remote time metric, and a bandwidth (BW) of the link from the local edge resource to the one or more remote edge resources. In addition, the compute resource is to store the one or more persistence properties in the remote storage metrics on the local edge resource.

In another example implementation, the compute resource is to further execute logic to filter which of the one or more edge resources at the edge of the network are capable of satisfying the criterion and select from filtered edge resources an edge resource that is capable of satisfying the criterion at a lowest cost.

In another example implementation, the compute resource is to further execute logic to record in the one or more edge resources a location of a data stored at the edge of the network after achieving persistence. Upon receipt of a request to access the data, the compute resource is to forward the request to access the data to an edge resource controlling the location.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
receiving a request to store data at an edge of a network, the request specifying a criterion for achieving persistence of stored data;
determining that one or more edge resources at the edge of the network is capable of satisfying the criterion; and
submitting the request to store data to a selected one of the one or more edge resources capable of satisfying the criterion.

2. A computer-implemented method as in claim 1, wherein the criterion for achieving persistence of stored data includes any one or more of:
a time within which to achieve persistence;
a cost within which to achieve persistence; and
a reliability with which to achieve persistence within any of the time and the cost.

3. A computer-implemented method as in claim 2, wherein the one or more edge resources at the edge of the network includes:
a local edge resource in which the request was received, the local edge resource controlling one or more local storage locations at the edge of the network; and
wherein determining that one or more edge resources at the edge of the network is capable of satisfying the criterion includes determining that any of the one or more local storage locations is capable of satisfying the criterion based on:
local storage metrics for the one or more local storage locations including any of a reliability metric and a time metric, and
a cost to store data in the one or more local storage locations based on the time and reliability metrics.

4. A computer-implemented method as in claim 3, wherein the one or more edge resources at the edge of the network further includes:
one or more remote edge resources accessible to the local edge resource; and
wherein determining that one or more remote edge resources is capable of satisfying the criterion is based on:
remote storage metrics for one or more remote storage locations including any of a remote reliability metric, a remote time metric, and a remote latency metric of a link from the local edge resource to the remote edge resource,
a remote cost to store data in the one or more remote storage locations based on the remote reliability, remote time and remote latency metrics.

5. A computer-implemented method as in claim 4, further comprising:
tracking via a radio access network (RAN) telemetry data provided to the local edge resource, one or more persistence properties of the one or more remote edge resources at the edge of the network, the one or more persistence properties including any of:
a persistence level (PL) indicating any of a percentage and a number representing the remote reliability metric,
a time-to-persistence (TTP) representing the remote time metric, and
a bandwidth (BW) of the link from the local edge resource to the one or more remote edge resources; and
storing the one or more persistence properties in the remote storage metrics on the local edge resource.

6. A computer-implemented method as in claim 2, further comprising:
filtering which of the one or more edge resources at the edge of the network are capable of satisfying the criterion; and
selecting from filtered edge resources an edge resource that is capable of satisfying the criterion at a lowest cost.

7. A computer-implemented method as in claim 1, further comprising:
recording in the one or more edge resources a location of a data stored at the edge of the network after achieving persistence;
receiving a request to access the data; and
forwarding the request to access the data to an edge resource controlling the location.

8. An edge computing system comprising:
a compute resource coupled to a storage resource, the compute resource to execute a logic to:
receive a request to store data at an edge of a network, the request specifying a criterion for achieving persistence of stored data;
determine that one or more edge resources at the edge of the network is capable of satisfying the criterion; and
submit the request to store data to a selected one of the one or more edge resources capable of satisfying the criterion.

9. An edge computing system as in claim 8, wherein the criterion for achieving persistence of stored data includes any one or more of:
a time within which to achieve persistence;
a cost within which to achieve persistence; and
a reliability with which to achieve persistence within any of the time and the cost.

10. An edge computing system as in claim 9, wherein the one or more edge resources at the edge of the network includes:
a local edge resource in which the request was received, the local edge resource to control one or more local storage locations at the edge of the network; and
wherein to determine that one or more edge resources at the edge of the network is capable of satisfying the criterion is to determine that any one or more local storage locations is capable of satisfying the criterion based on:
local storage metrics for the one or more local storage locations including any of a reliability metric and a time metric, and
a cost to store data in the one or more local storage locations based on the time and reliability metrics.

11. An edge computing system as in claim 10, wherein the one or more edge resources at the edge of the network further includes:
one or more remote edge resources accessible to the local edge resource; and
wherein to determine that one or more remote edge resources is capable of satisfying the criterion is based on:
remote storage metrics for one or more remote storage locations including any of a remote reliability metric, a remote time metric, and a remote latency metric of a link from the local edge resource to the remote edge resource,
a remote cost to store data in the one or more remote storage locations based on the remote reliability, remote time and remote latency metrics.

12. An edge computing system as in claim 11, the compute resource to further execute logic to:
track via a radio access network (RAN) telemetry data provided to the local edge resource, one or more persistence properties of the one or more remote edge resources at the edge of the network, the one or more persistence properties including any of:
a persistence level (PL) indicating any of a percentage and a number representing the remote reliability metric,
a time-to-persistence (TTP) representing the remote time metric, and
a bandwidth (BW) of the link from the local edge resource to the one or more remote edge resources; and
store the one or more persistence properties in the remote storage metrics on the local edge resource.

13. An edge computing system as in claim 9, the compute resource to further execute logic to:
filter which of the one or more edge resources at the edge of the network are capable of satisfying the criterion; and
select from filtered edge resources an edge resource that is capable of satisfying the criterion at a lowest cost.

14. An edge computing system as in claim 8, the compute resource to further execute logic to:
record in the one or more edge resources a location of a data stored at the edge of the network after achieving persistence;
receive a request to access the data; and
forward the request to access the data to an edge resource controlling the location.

15. A server comprising:
an edge gateway to an edge computing system having one or more edge resources; and
circuitry coupled to the edge gateway, the circuitry to:
receive a request to store data at the edge gateway, the request specifying a criterion for achieving persistence of stored data;
determine that any of the edge gateway and one or more edge resources of the edge computing system is capable of satisfying the criterion; and
submit the request to store data to any of the edge gateway and a selected one of the one or more edge resources capable of satisfying the criterion.

16. A server as in claim 15, wherein the criterion for achieving persistence of stored data includes any one or more of:
a time within which to achieve persistence;
a cost within which to achieve persistence; and
a reliability with which to achieve persistence within any of the time and the cost.

17. A server as in claim 16, wherein the one or more edge resources of the edge computing system includes:
the edge gateway in which the request was received, the edge gateway to control one or more local storage locations in the edge computing system; and
wherein to determine that one or more edge resources of the edge computing system is capable of satisfying the criterion includes to determine that any one or more local storage locations is capable of satisfying the criterion based on:
local storage metrics for the one or more local storage locations including any of a reliability metric and a time metric, and
a cost to store data in the one or more local storage locations based on the time and reliability metrics.

18. A server as in claim 17, wherein the one or more edge resources of the edge computing system further includes:
one or more remote edge resources accessible to the edge gateway; and
wherein to determine that one or more remote edge resources is capable of satisfying the criterion is based on:
remote storage metrics for one or more remote storage locations including any of a remote reliability metric, a remote time metric, and a remote latency metric of a link from the edge gateway to the remote edge resource,
a remote cost to store data in the one or more remote storage locations based on the remote reliability, remote time and remote latency metrics.

19. A server as in claim 18, the circuitry further to:
track via a radio access network (RAN) telemetry data provided to the edge gateway one or more persistence properties of the one or more remote edge resources of the edge computing system, the persistence properties including any of:
a persistence level (PL) indicating any of a percentage and a number representing the remote reliability metric,
a time-to-persistence (TTP) representing the remote time metric, and
a bandwidth (BW) of the link from the edge gateway to the remote edge resource;
storing the persistence properties in the remote storage metrics on the edge gateway.

20. A server as in claim 16, the circuitry further to:
filter which of the one or more edge resources of the edge computing system are capable of satisfying the criterion; and
select from filtered edge resources an edge resource that is capable of satisfying the criterion at a lowest cost.

21. A server as in claim 15, the circuitry further to:
record in the one or more edge resources a location of a data stored in the edge computing system after achieving persistence;
receive a request to access the data; and
forward the request to access the data to an edge resource controlling the location.
